(19) United States
(12) Patent Application Publication
(10) Pub. No.: US 2025/0291040 A1
(43) Pub. Date: Sep. 18, 2025

(54) TRACKER FOR LOCATION-VARYING DIRECTED LIGHT TRACKING, TESTER WITH SUCH A TRACKER, AND CORRESPONDING METHOD

(71) Applicant: Rohde & Schwarz GmbH & Co. KG, Munich (DE)

(72) Inventors: Benedikt SIMPER, Buch Am Erlbach (DE); Maximilian FINK, Munich (DE); Moritz UEFFING, Munich (DE)

(73) Assignee: Rohde & Schwarz GmbH & Co. KG, Munich (DE)

(21) Appl. No.: 18/604,652

(22) Filed: Mar. 14, 2024

(51) Int. Cl. G01S 7/497; G01S 7/499

(52) U.S. Cl. CPC G01S 7/497; G01S 7/499

(57) ABSTRACT

A tracker for tracking timing and impact location with respect to directed light whose location varies over time is provided. The tracker includes receive optics, a polarization element, optical modulator, imaging element, and controller. The receive optics receives an impact location of the directed light as received light and provides the received light for the polarization element. The polarization element makes the received light polarized in the same direction and provides the correspondingly polarized light for the optical modulator. The optical modulator changes the polarization of the polarized light over a controlled period and provides the correspondingly polarization-changed light for the imaging element. The imaging element spatially resolves the corresponding polarization intensities of the respective polarization directions of the polarization-changed light and provides the polarization intensities for the controller. The controller maps the corresponding locations and polarization intensities to the respective modulation time associated with that corresponding polarization.

### TECHNICAL FIELD

The disclosure relates to tracking timing and impact location with respect to directed light whose location varies over time. In particular, the disclosure relates to a tracker for tracking timing and impact location with respect to directed light whose location varies over time, a tester for testing a directed light emitting device, especially a lidar sensor, and a method for tracking timing and impact location with respect to directed light whose location varies over time.

### BACKGROUND ART

Generally, in times of an increasing number of applications employing directed light emitting devices, such as autonomous driving applications employing lidar (light detection and ranging) sensors, there is a growing need of a tracker for tracking timing and impact location with respect to directed light whose location varies over time, a tester for testing a directed light emitting device, especially a lidar sensor, and a method for tracking timing and impact location with respect to directed light whose location varies over time in order to verify correct functioning of said applications in a highly accurate and efficient manner.

U.S. Pat. No. 10,104,365 B2 discloses methods and systems which should improve upon previous 3D imaging techniques by making use of a longer illumination pulse to obtain the same or nearly the same range resolution as can be achieved by using a much shorter, conventional laser pulse. For example, a longer illumination pulse can be produced by one or more Q-switched lasers that produce, for example, 5, 10, 20 ns or longer pulses. In some instances, the laser pulse can be longer than the modulation waveform of a modulated imaging system and still produce a repeatable response function.

Disadvantageously, said methods and systems do not allow for tracking location-varying directed light, especially in the sense of a time and spatially resolved result or a time and spatially resolved image, respectively.

### SUMMARY

Thus, there is a need to provide a tracker for tracking timing and impact location with respect to directed light whose location varies over time, a tester for testing a directed light emitting device, especially a lidar sensor, and a method for tracking timing and impact location with respect to directed light whose location varies over time, wherein a time and spatially resolved result or a time and spatially resolved image, respectively, can accurately and efficiently be created.

This is achieved by the embodiments provided in the enclosed independent claims. Advantageous implementations of the present disclosure are further defined in the dependent claims.

According to a first aspect of the disclosure, a tracker for tracking timing and impact location with respect to directed light whose location varies over time is provided. Said tracker comprises receive optics, a polarization element, an optical modulator, an imaging element, and a controller. The receive optics is configured to receive an impact location of the directed light as received light and to provide said received light for the polarization element. Furthermore, said polarization element is configured to make the received light polarized in the same direction and to provide the correspondingly polarized light for the optical modulator. Moreover, said optical modulator is configured to change the polarization of said polarized light over a controlled period and to provide the correspondingly polarization-changed light for the imaging element. Additionally, said imaging element is configured to spatially resolve the corresponding polarization intensities of the respective polarization directions of said polarization-changed light and to provide said polarization intensities for the controller. Further additionally, said controller is configured to map the corresponding locations and polarization intensities to the respective modulation time associated with that corresponding polarization. Advantageously, a time and spatially resolved result or a time and spatially resolved image, respectively, can accurately and efficiently be created.

According to an implementation form of the first aspect of the disclosure, the controller is configured to create a pattern map for the corresponding locations over time. Advantageously, for instance, a scan pattern with respect to the directed light can be recorded in a particularly efficient manner.

According to a further implementation form of the first aspect of the disclosure, the receive optics comprises or is at least one of a screen, one or more diffusors, one or more structured diffusors, a focusing element, a lens, an imaging lens, or any combination thereof. Advantageously, for example, the receive optics can scatter the directed light such that the received light does not have any dominant polarization in a particularly efficient manner.

According to a further implementation form of the first aspect of the disclosure, the polarization element comprises or is a polarization filter and/or a polarization grid. Advantageously, for instance, complexity can be reduced, thereby increasing efficiency.

According to a further implementation form of the first aspect of the disclosure, the optical modulator comprises or is a polarization modulator and/or a Pockels cell. Advantageously, for example, a Pockels cell can modulate the polarization angle of the corresponding light in a particularly efficient manner.

According to a further implementation form of the first aspect of the disclosure, the imaging element comprises or is a polarization beam splitter and/or at least two optical sensors, preferably at least two camera sensors, more preferably two optical sensors, most preferably two camera sensors, and/or at least two focal-plane arrays, preferably two focal-plane arrays. Advantageously, for instance, complexity can be reduced, which leads to an increased efficiency.

According to a further implementation form of the first aspect of the disclosure, the imaging element comprises or is a polarization determining optical sensor, preferably a polarization determining camera sensor. Advantageously, for example, vertical and horizontal polarization can separately be recorded in a particularly efficient manner.

According to a further implementation form of the first aspect of the disclosure, the receive optics is configured to scatter the directed light in a Lambertian distribution or substantially in a Lambertian distribution. Advantageously, for instance, an eventual polarization is efficiently not maintained.

According to a further implementation form of the first aspect of the disclosure, the optical modulator is configured to sweep, preferably linearly sweep, through a corresponding modulation ramp, especially over the whole controlled period. Advantageously, for example, efficiency can further be increased.

According to a further implementation form of the first aspect of the disclosure, a sweep time of the optical modulator is set depending on a frame rate with respect to the directed light. Advantageously, for instance, the tracker can be set up in a particularly efficient manner.

According to a further implementation form of the first aspect of the disclosure, the sweep time is in a reciprocal relationship to the frame rate. Advantageously, for example, complexity can be reduced, thereby increasing efficiency.

With respect to the above-mentioned sweep time, it is noted that it might be particularly advantageous if the sweep time is between 1/300 s and ⅕ s, preferably between 1/150 s and 1/10 s, more preferably between 1/100 s and 1/20 s, most preferably between 1/90 s and 1/30 s. Advantageously, for instance, directed light can efficiently and accurately be tracked, which is emitted by a directed light emitting device or a lidar sensor, respectively, exemplarily with a frame rate of 30 fps (frames per second) or 60 fps or 125 fps.

According to a further implementation form of the first aspect of the disclosure, the optical modulator is configured to apply the corresponding polarization modulation to the polarized light depending on a respective time delay. Advantageously, for example, efficiency can further be increased.

According to a further implementation form of the first aspect of the disclosure, the screen comprises or is a partially reflective screen, a reflective screen, a partially transmissive screen, a transmissive screen, or any combination thereof. Advantageously, for instance, the screen can especially be a diffusor screen.

According to a further implementation form of the first aspect of the disclosure, the controller is configured to compare the pattern map to a reference pattern map. Advantageously, for example, the corresponding alignment of a scan pattern of the directed light emitting device or a lidar sensor, respectively, compared to the specification of the scan pattern, especially by the manufacturer, can be determined.

According to a second aspect of the disclosure, a tester for testing a directed light emitting device, especially a lidar sensor, is provided. Said tester comprises a tracker according to the first aspect of the disclosure or any of its implementation forms, respectively. Advantageously, a time and spatially resolved result or a time and spatially resolved image, respectively, can accurately and efficiently be created.

According to an implementation form of the second aspect of the disclosure, the tester further comprises a light signal transmitter, wherein the light signal transmitter is configured to transmit a light signal towards the directed light emitting device as a response to the directed light emitted by the directed light emitting device. Advantageously, for instance, a lidar target can efficiently be emulated or simulated, respectively.

According to a further implementation form of the second aspect of the disclosure, the controller of the tracker is configured to control the corresponding direction of the light signal to aim the response for the same impact location of the directed light as currently received by the receive optics of the tracker. Advantageously, for example, efficiency with respect to lidar target emulation or simulation, respectively, can further be increased.

According to a third aspect of the disclosure, a method, especially using the tracker according to the first aspect of the disclosure or any of its implementation forms, respectively, for tracking timing and impact location with respect to directed light whose location varies over time is provided. Said method comprises the steps of receiving an impact location of the directed light as received light, making the received light polarized in the same direction, changing the polarization of the correspondingly polarized light over a controlled period, spatially resolving the corresponding polarization intensities of the respective polarization directions of the correspondingly polarization-changed light, and mapping the corresponding locations and polarization intensities to the respective modulation time associated with that corresponding polarization. Advantageously, a time and spatially resolved result or a time and spatially resolved image, respectively, can accurately and efficiently be created.

According to an implementation form of the third aspect of the disclosure, the method further comprises the step of creating a pattern map for the corresponding locations over time. Advantageously, for instance, a scan pattern with respect to the directed light can be recorded in a particularly efficient manner.

According to a further implementation form of the third aspect of the disclosure, the method further comprises the step of comparing the pattern map to a reference pattern map. Advantageously, for example, the corresponding alignment of a scan pattern of the directed light emitting device or a lidar sensor, respectively, compared to the specification of the scan pattern, especially by the manufacturer, can be determined.

### BRIEF DESCRIPTION OF THE DRAWINGS

The above-described aspects and implementation forms of the present disclosure will be explained in the following description of specific embodiments in relation to the enclosed drawings, in which:

FIG. 1 shows an exemplary embodiment of a tracker for tracking timing and impact location with respect to directed light whose location varies over time;

FIG. 2 shows a further exemplary embodiment of a tracker for tracking timing and impact location with respect to directed light whose location varies over time;

FIG. 3 shows an exemplary curve of the corresponding polarization angle over time with respect to the tracker according to FIG. 2;

FIG. 4 shows exemplary polarization intensities with respect to the tracker according to FIG. 2;

FIG. 5 shows an exemplary tracking result with respect to the tracker according to FIG. 2;

FIG. 6 shows an exemplary embodiment of a tester comprising the tracker according to FIG. 1 for testing a directed light emitting device; and

FIG. 7 shows a flow chart of an exemplary embodiment of a method for tracking timing and impact location with respect to directed light whose location varies over time.

### DETAILED DESCRIPTIONS OF EMBODIMENTS

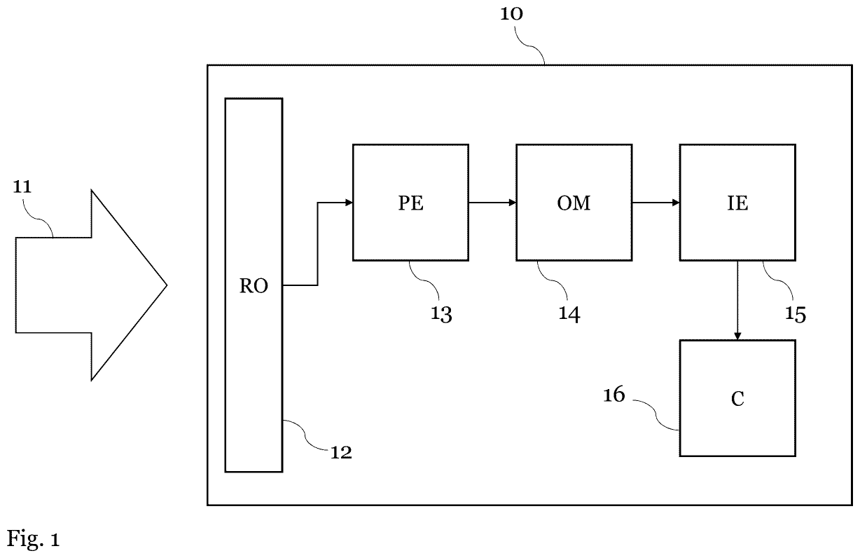

With respect to FIG. 1, an exemplary embodiment of a tracker 10 for tracking timing and impact location with respect to directed light 11 whose location varies over time is depicted. Said tracker 10 comprises receive optics 12, a polarization element 13, an optical modulator 14, an imaging element 15, and a controller 16.

The receive optics 12 is configured to receive an impact location of the directed light 11 as received light and to provide said received light for the polarization element 13. Furthermore, said polarization element 13 is configured to make the received light polarized in the same direction and to provide the correspondingly polarized light for the optical modulator 14. Moreover, said optical modulator 14 is configured to change the polarization of said polarized light over a controlled period and to provide the correspondingly polarization-changed light for the imaging element 15. In addition to this, said imaging element 15 is configured to spatially resolve the corresponding polarization intensities of the respective polarization directions of said polarization-changed light and to provide said polarization intensities for the controller 16. Further additionally, said controller 16 is configured to map the corresponding locations and polarization intensities to the respective modulation time associated with that corresponding polarization.

It is noted that it might be particularly advantageous if the controller 16 is configured to create a pattern map for the corresponding locations over time.

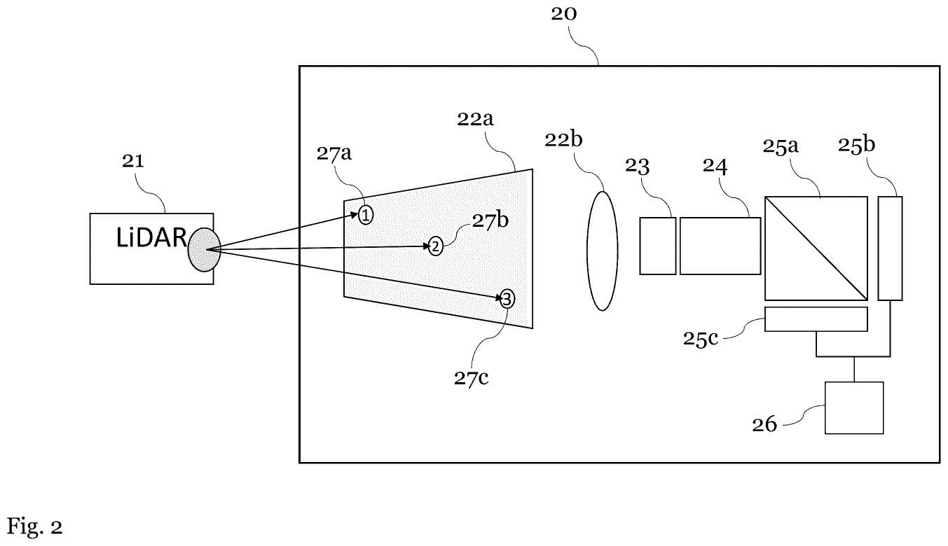

Now, with respect to FIG. 2, a further exemplary embodiment of a tracker 20 for tracking timing and impact location with respect to directed light whose location varies over time is illustrated. As it can exemplarily be seen, said directed light is emitted by a lidar (light detection and ranging) sensor 21.

The tracker 20 comprises a screen 22a and a focusing element, exemplarily a lens 22b. Said screen 22a and said lens 22b may especially be seen as the above-mentioned receive optics 12. Accordingly, the explanations above regarding said receive optics 12 can analogously apply for the screen 22a or the lens 22b, respectively, and vice versa.

It is generally noted that it might be particularly advantageous if the receive optics 12 comprises or is a screen and/or one or more diffusors and/or one or more structured diffusors and/or a focusing element and/or a lens and/or an imaging lens.

Furthermore, the tracker 20 exemplarily comprises a polarization grid 23. Said polarization grid 23 may especially be seen as the above-mentioned polarization element 13. Accordingly, the explanations above regarding said polarization element 13 can analogously apply for the polarization grid 23, and vice versa. Generally, it might be particularly advantageous if the polarization element 13 comprises or is a polarization filter and/or a polarization grid.

Moreover, the tracker 20 exemplarily comprises a polarization modulator 24. Said polarization modulator 24 may especially be seen as the above-mentioned optical modulator 14. Accordingly, the explanations above regarding said optical modulator 14 can analogously apply for the polarization modulator 24, and vice versa. Generally, it might be particularly advantageous if the optical modulator 14 comprises or is a polarization modulator and/or a Pockels cell.

As it can further be seen from FIG. 2, the tracker 20 exemplarily comprises a polarization beam splitter 25a, a first camera sensor 25b, especially a first focal-plane array, and a second camera sensor 25c, especially a second focal-plane array. Said polarization beam splitter 25a, said first camera sensor 25b, and said second camera sensor may especially be seen as the above-mentioned imaging element 15. Accordingly, the explanations above regarding said imaging element 15 can analogously apply for the polarization beam splitter 25a, the first camera sensor 25b, the second camera sensor 25c, and vice versa.

Generally, it might be particularly advantageous if the imaging element 15 comprises or is a polarization beam splitter and/or at least two optical sensors, preferably at least two camera sensors, more preferably two optical sensors, most preferably two camera sensors, and/or at least two focal-plane arrays. Furthermore, the imaging element 15 can comprise or be a polarization determining optical sensor, preferably a polarization determining camera sensor.

In particular, in the exemplary case according to FIG. 2, the lidar sensor 21 transmits its directed light or optical signal, respectively, to the screen 22a, especially a diffusor screen. It is noted that it might be particularly advantageous if the screen 22a comprises or is a partially reflective screen, a reflective screen, a partially transmissive screen, a transmissive screen, or any combination thereof. It is further noted that FIG. 2 exemplarily illustrates three exemplary impact locations or pixels, respectively, of the directed light on the screen 22a, which are equipped with reference signs 27a, 27b, 27c.

Furthermore, the screen 22a is exemplarily configured to scatter the directed light in a Lambertian distribution or substantially in a Lambertian distribution, especially towards the focusing element or lens 22b, respectively. It is noted that the foregoing term “substantially” may especially be understood as a corresponding deviation of not more than 10 percent, preferably not more than 5 percent, more preferably not more than 3 percent, most preferably not more than 1 percent.

It is further noted that it might be particularly advantageous if the screen 22a is configured to not be polarization maintaining. Generally, it might be particularly advantageous if the receive optics 12 is configured to not be polarization maintaining.

Moreover, the focusing element or lens 22b, respectively, is exemplarily configured to focus the corresponding light of the screen 22a, especially onto the polarization grid 23 or polarization filter, respectively. Generally, it might be particularly advantageous if the receive optics 12 is configured to focus the received light, especially onto the polarization element 13.

Additionally, the polarization grid 23 or polarization filter, respectively, is configured to convert the light, especially unpolarized light, from the focusing element or lens 22b, respectively, into a single linear polarization, for instance, purely horizontal or purely vertical. Generally, it might be particularly advantageous if the polarization element 13 is configured to convert the received light, especially being unpolarized light, into a single linear polarization, for instance, purely horizontal or purely vertical.

Further exemplarily, the polarization modulator 24 or the Pockels cell, respectively, is configured to modulate the polarization of the linearly polarized light over time. Generally, it might be particularly advantageous if the optical modulator 14 is configured to modulate the polarization of the polarized light, especially linearly polarized light, over time. Furthermore, it might be particularly advantageous if the polarization modulator 24, exemplarily the Pockels cell, or the optical modulator 14, respectively, is configured to sweep, preferably linearly sweep, through a corresponding modulation ramp, especially over the whole controlled period.

It is further noted that it might be particularly advantageous if a sweep time of the polarization modulator 24 or the optical modulator 14, respectively, is set depending on a frame rate with respect to the directed light or a frame rate of the lidar sensor 21, respectively. Said sweep time may especially be in a reciprocal relationship to the frame rate. It might be particularly advantageous if the sweep time is between 1/300 s and ⅕ s, preferably between 1/150 s and 1/10 s, more preferably between 1/100 s and 1/20 s, most preferably between 1/90 s and 1/30 s. Moreover, it might be particularly advantageous if the frame rate is between 5 fps (frames per second) and 300 fps, preferably between 10 fps and 150 fps, more preferably between 20 fps and 100 fps, most preferably between 30 fps and 90 fps.

Further exemplarily, the polarized light or polarization-changed light, respectively, is guided through the polarization beam splitter 25a. Said polarization beam splitter 25a is exemplarily configured to split the polarized light or polarization-changed light, respectively, into a vertical and a horizontal light component.

As it can further be seen from FIG. 2, the single light components are exemplarily imaged onto the first camera sensor 25b or the first focal-plane array, respectively, and the second camera sensor 25c or the second focal-plane array, respectively.

The first camera sensor 25b or the first focal-plane array, respectively, and the second camera sensor 25c or the second focal-plane array, respectively, are exemplarily configured to spatially resolve the intensity of the vertical and horizontal light components.

With respect to the polarization modulator 24 or the optical modulator 14, respectively, it is noted that it might be particularly advantageous if the polarization modulator 24 or the optical modulator 14, respectively, is configured to apply the corresponding polarization modulation to the polarized light depending on a respective time delay.

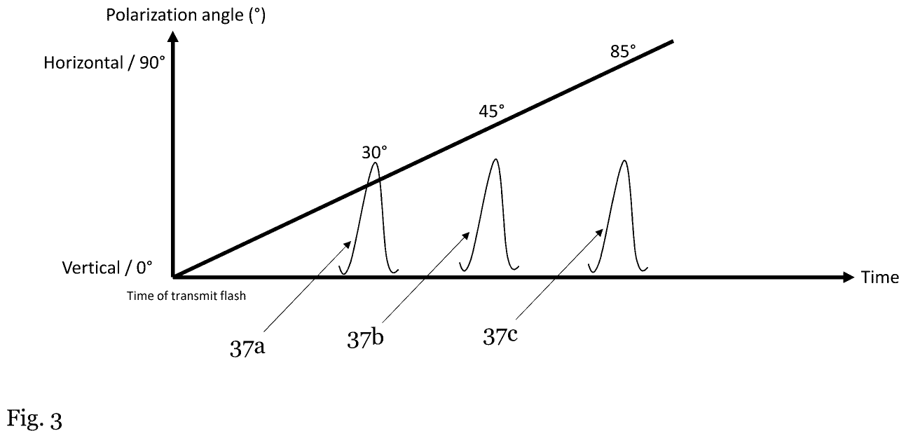

Accordingly, depending on the time delay, a different polarization modulation may especially be applied to the incoming light pulse, which is exemplarily illustrated by FIG. 3 depicting an exemplary curve of the corresponding polarization angle over time, wherein the light pulses 37a, 37b, 37c correspond the above-mentioned impact locations of the directed light or pixels 27a, 27b, 27c, respectively. In particular, light pulse 37a at a polarization angle of 30 degrees corresponds to pixel 27a, light pulse 37b at a polarization angle of 45 degrees corresponds to pixel 27b, and light pulse 37c at a polarization angle 85 degrees corresponds to pixel 27c.

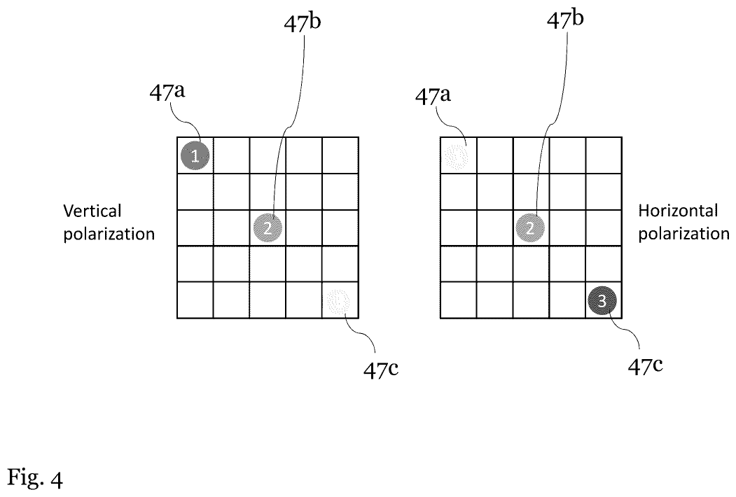

Now, with respect to FIG. 4, exemplary polarization intensities with reference signs 47a, 47b, 47c are shown with respect to the tracker 20 according to FIG. 2. In this context, it is noted that one of the camera sensors 25b, 25c or focal-plane arrays, respectively, is configured to only measure vertical polarization and one is configured to only measure horizontal polarization. It is further noted that intensity 47a corresponds to the above-mentioned pixel 27a, intensity 47b corresponds to the above-mentioned pixel 27b, and intensity 47c corresponds to the above-mentioned pixel 27c.

Especially with the aid of the controller 26, depending on the intensity relationship between the two camera sensors 25b, 25c, the polarization of the received light can be detected. Accordingly, it might be particularly advantageous if the controller 26 or the controller 16 is configured to determine the polarization of the polarization-changed light or the polarization-modulated light, respectively, depending on the intensity relationship between the two camera sensors 25b, 25c.

Furthermore, it might be particularly advantageous if the controller 26 or the controller 16 is configured to derive the time when the directed light or specific signal, respectively, was received, especially from the determined polarization and the known polarization modulation ramp.

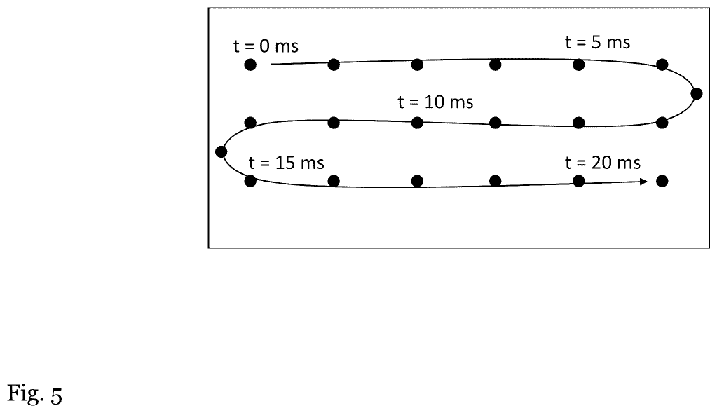

In the light of FIG. 5 showing an exemplary tracking result with respect to the tracker 20 according to FIG. 2, an exemplary use case of said tracker 20 is described in the following.

For instance, after the polarization grid 23, the light received by the screen 22a is purely vertically polarized. The polarization modulator 24 modulates the incoming light starting from purely vertically polarized (0° shift) to purely horizontally polarized (90° shift). The polarization modulator 24 linearly sweeps through the modulation ramp over the whole detection period.

For example, the scan pattern of the lidar sensor 21 scanning with 30 fps should be recorded. Accordingly, the sweep time of the polarization modulator 24 is 1/30 s. The exposure time of the camera sensors 25b, 25c is then also 1/30 s.

Light arriving at t=0 s will have a polarization modulation of 0°+0°=0°. So, for instance, when the lidar sensor 21 under test sends out a pulse at t=0 s to the top left of the screen 22a, the top left pixel, such as the pixel 27a, of the vertical polarization camera sensor will receive a strong signal, whereas the top left pixel of the horizontal polarization camera sensor will receive no signal at all as illustrated by reference sign 47a in FIG. 4.

Furthermore, light arriving at t=0.5* 1/30 s will have a polarization of 0°+45°=45°. So, for example, when the lidar sensor 21 under test sends out a pulse at t=0.5* 1/30 s to the center of the screen, the center pixel, such as the pixel 27b, of both the vertical and horizontal polarization camera sensor will receive the identical amount of light as illustrated by reference sign 47b in FIG. 4.

Moreover, light arriving at t= 1/30 s will have a polarization of 0°+90°=90°. So, for instance, when the lidar sensor 21 under test sends out a pulse at t= 1/30 s to bottom right of the screen, the bottom right pixel, such as the pixel 27c, of the vertical polarization camera sensor will receive no signal and the horizontal polarization camera sensor will receive a strong signal as illustrated by reference sign 47c in FIG. 4.

Advantageously, as illustrated by FIG. 5, for each impact location or each pixel, respectively, the intensity difference between the vertical and horizontal polarization camera sensor s 25b, 25c directly results in a calculatable time of arrival. Further advantageously, a spatially and temporal resolved image of the corresponding scan pattern of the scanning lidar sensor 21 is created.

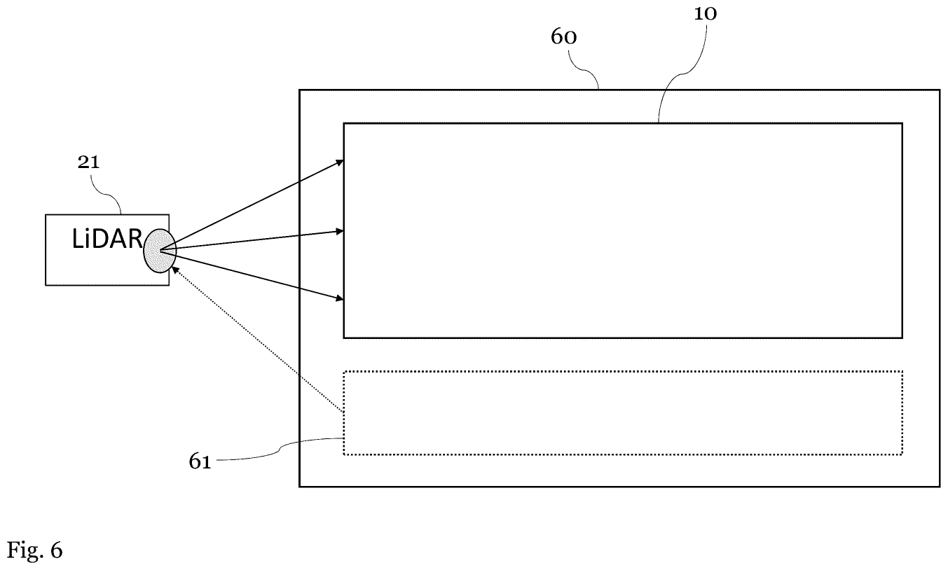

Now, with respect to FIG. 6, a tester 60 for testing a directed light emitting device, especially a lidar sensor, exemplarily the lidar sensor 21 according to FIG. 2. Said tester 60 comprises the tracker 10 according to FIG. 1.

As it can be seen from said FIG. 6, it might be particularly advantageous if the tester 60 further comprises a light signal transmitter 61, wherein said light signal transmitter 61 is configured to transmit a light signal towards the directed light emitting device or the lidar sensor 21, respectively, as a response to the directed light emitted by the directed light emitting device or the lidar sensor, respectively.

It is noted that it might be particularly advantageous if the controller 16 of the tracker 10 is configured to control the corresponding direction of the light signal to aim the response for the same impact location of the directed light as currently received by the receive optics 12 of the tracker 10.

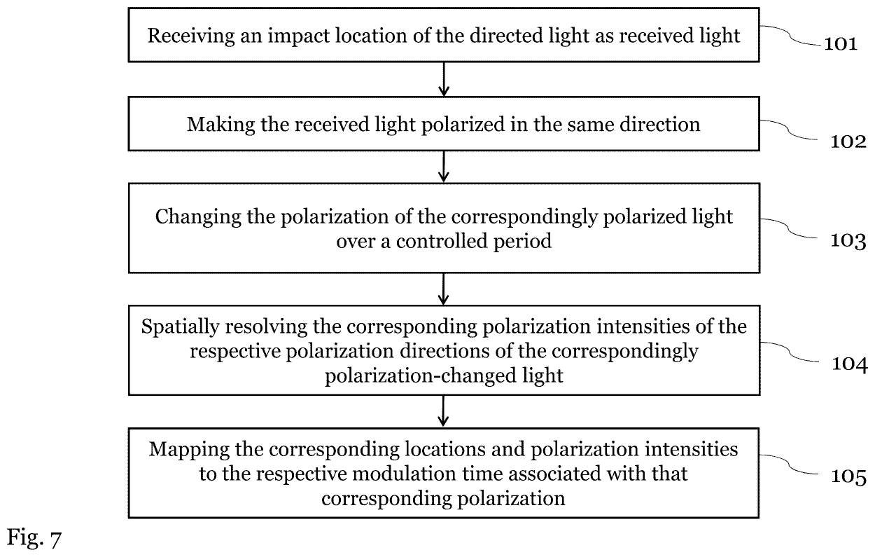

Finally, FIG. 7 illustrates a flow chart of an exemplary embodiment of a method, exemplarily using the tracker 10 of FIG. 1 or the tracker 20 of FIG. 2, for tracking timing and impact location with respect to directed light whose location varies over time. A first step 101 comprises receiving an impact location of the directed light, such as the above-mentioned directed light 11, as received light, exemplarily with the aid of the receive optics 12 or with the aid of the screen 22a and/or the lens 22b. A second step 102 comprises making the received light polarized in the same direction, exemplarily with the aid of the polarization element 13 or with the aid of the polarization grid 23 or polarization filter, respectively. A third step 103 comprises changing the polarization of the correspondingly polarized light over a controlled period, exemplarily with the aid of the optical modulator 14 or with the aid of the polarization modulator 24 or the Pockels cell, respectively. Furthermore, a fourth step 104 comprises spatially resolving the corresponding polarization intensities of the respective polarization directions of the correspondingly polarization-changed light, exemplarily with the aid of the imaging element 15 or with the aid of the polarization beam splitter 25 and/or the first camera sensor 25b or the first focal-plane array, respectively, and/or the second camera sensor 25c or the second focal-plane array, respectively. Moreover, a fifth step 105 comprises mapping the corresponding locations and polarization intensities to the respective modulation time associated with that corresponding polarization, exemplarily with the aid of the controller 16 or with the aid of the controller 26.

It is noted that it might be particularly advantageous if the method comprises the step of creating a pattern map for the corresponding locations over time, exemplarily with the aid of the controller 16 or with the aid of the controller 26.

It is further noted that it might be particularly advantageous if, especially in the context of the step 101, the method comprises the step of scattering the directed light in a Lambertian distribution or substantially in a Lambertian distribution, exemplarily with the aid of the receive optics 12 or with the aid of the screen 22a.

Furthermore, it might be particularly advantageous if, especially in the context of step 103, the method comprises the step of sweeping, preferably linearly sweeping, through a corresponding modulation ramp, especially over the whole controlled period, exemplarily with the aid of the optical modulator 14 or with the aid of the polarization modulator 24 or the Pockels cell, respectively.

Moreover, it might be particularly advantageous if, especially in the context of step 103, the method comprises the step of setting a corresponding sweep time depending on a frame rate with respect to the directed light.

In this context, it is noted that it might be particularly advantageous if the sweep time is in a reciprocal relationship to the frame rate. Additionally or alternatively, the sweep time may especially be between 1/300 s and ⅕ s, preferably between 1/150 s and 1/10 s, more preferably between 1/100 s and 1/20 s, most preferably between 1/90 s and 1/30 s.

It is further noted that it might be particularly advantageous if, especially in the context of step 103, the method comprises the step of applying the corresponding polarization modulation to the polarized light depending on a respective time delay, exemplarily with the aid of the optical modulator 14 or with the aid of the polarization modulator 24 or Pockels cell, respectively.

Moreover, it might be particularly advantageous if, especially in the context of creating the pattern map, the method comprises the step of comparing the pattern map to a reference pattern map, exemplarily with the aid of the controller 16 or with the aid of the controller 26.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above-described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

What is claimed is:

1. A tracker for tracking timing and impact location with respect to directed light whose location varies over time, comprising:
receive optics,
a polarization element,
an optical modulator,
an imaging element, and
a controller,
wherein the receive optics is configured to receive an impact location of the directed light as received light and to provide said received light for the polarization element,
wherein said polarization element is configured to make the received light polarized in the same direction and to provide the correspondingly polarized light for the optical modulator,
wherein said optical modulator is configured to change the polarization of said polarized light over a controlled period and to provide the correspondingly polarization-changed light for the imaging element,
wherein said imaging element is configured to spatially resolve the corresponding polarization intensities of the respective polarization directions of said polarization-changed light and to provide said polarization intensities for the controller, and
wherein said controller is configured to map the corresponding locations and polarization intensities to the respective modulation time associated with that corresponding polarization.

2. The tracker according to claim 1,
wherein the controller is configured to create a pattern map for the corresponding locations over time.

3. The tracker according to claim 1,
wherein the receive optics comprises or is at least one of a screen, one or more diffusors, one or more structured diffusors, a focusing element, a lens, an imaging lens, or any combination thereof.

4. The tracker according to claim 1,
wherein the polarization element comprises or is a polarization filter and/or a polarization grid.

5. The tracker according to claim 1,
wherein the optical modulator comprises or is a polarization modulator and/or a Pockels cell.

6. The tracker according to claim 1,
wherein the imaging element comprises or is a polarization beam splitter and/or at least two optical sensors, preferably at least two camera sensors, more preferably two optical sensors, most preferably two camera sensors, and/or at least two focal-plane arrays.

7. The tracker according to claim 1,
wherein the imaging element comprises or is a polarization determining optical sensor, preferably a polarization determining camera sensor.

8. The tracker according to claim 1,
wherein the receive optics is configured to scatter the directed light in a Lambertian distribution or substantially in a Lambertian distribution.

9. The tracker according to claim 1,
wherein the optical modulator is configured to sweep, preferably linearly sweep, through a corresponding modulation ramp, especially over the whole controlled period.

10. The tracker according to claim 1,
wherein a sweep time of the optical modulator is set depending on a frame rate with respect to the directed light.

11. The tracker according to claim 10,
wherein the sweep time is in a reciprocal relationship to the frame rate.

12. The tracker according to claim 1,
wherein the optical modulator is configured to apply the corresponding polarization modulation to the polarized light depending on a respective time delay.

13. The tracker according to claim 3,
wherein the screen comprises or is a partially reflective screen, a reflective screen, a partially transmissive screen, a transmissive screen, or any combination thereof.

14. The tracker according to claim 2,
wherein the controller is configured to compare the pattern map to a reference pattern map.

15. A tester for testing a directed light emitting device, especially a lidar sensor, comprising:
a tracker according to claim 1.

16. The tester according to claim 15, further comprising:
a light signal transmitter,
wherein the light signal transmitter is configured to transmit a light signal towards the directed light emitting device as a response to the directed light emitted by the directed light emitting device.

17. The tester according to claim 16,
wherein the controller of the tracker is configured to control the corresponding direction of the light signal to aim the response for the same impact location of the directed light as currently received by the receive optics of the tracker.

18. A method, especially using the tracker according to claim 1, for tracking timing and impact location with respect to directed light whose location varies over time, comprising the steps of:
receiving an impact location of the directed light as received light, making the received light polarized in the same direction,
changing the polarization of the correspondingly polarized light over a controlled period,
spatially resolving the corresponding polarization intensities of the respective polarization directions of the correspondingly polarization-changed light, and
mapping the corresponding locations and polarization intensities to the respective modulation time associated with that corresponding polarization.

19. The method according to claim 18, further comprising the step of:
creating a pattern map for the corresponding locations over time.

20. The method according to claim 19, further comprising the step of:
comparing the pattern map to a reference pattern map.
